(19) United States
(12) Patent Application Publication
(10) Pub. No.: US 2017/0178057 A1
(43) Pub. Date: Jun. 22, 2017

(54) LOGISTICS NAVIGATION ROUTING USING MOBILE DEVICE LOCATION CAPABILITIES

(71) Applicant: MENA360 DWC-LLC, Dubai Logistics City (AE)

(72) Inventor: Idriss O. Al Rifai, Dubai Logistics City (AE)

(21) Appl. No.: 15/384,022

(22) Filed: Dec. 19, 2016

Related U.S. Application Data
(60) Provisional application No. 62/269,479, filed on Dec. 18, 2015.

(51) Int. Cl. G06Q 10/08; H04W 4/02

(52) U.S. Cl. CPC G06Q 10/083; H04W 4/02

(57) ABSTRACT

Technology is disclosed for logistics navigation of products without a physical address. The geographic location of a customer can be determined by a mobile device used to request delivery of the product. The mobile device can use its own location determination capabilities to provide the geographic location to a logistics server. The logistics server can then provide that geographic location to a device of a logistics driver such that the product can be delivered without a physical address such as a street address.

### CLAIM FOR PRIORITY

This application claims priority to U.S. Provisional Patent Application No. 62/269,479, entitled “Platform For Selling Products On Social Media,” by Rifai, and filed on Dec. 18, 2015. The content of the above-identified application is incorporated by reference in its entirety.

### BACKGROUND

Ecommerce in areas such as the Middle East is booming and is expected to hit 15 billion U.S. dollars by the year of 2016. Particularly, product sales on social media platforms (also referred to as “social selling”) is becoming popular. Social selling is disrupting ecommerce as it empowers people to sell products directly to customers. This is particularly useful for sellers who do not have the ability or resource to set up their own online store, such as local craftsmen and work-at-home women.

However, there are issues with payment gateway integration and ecommerce setup. For example, in some countries and areas, there is no street address or house numbering system. For instance, some streets in Dubai, United Arab Emirates have street names; however, many streets do not have a unique number to identify each building in a street. As a result, it is not easy to locate a particular building in Dubai for the purpose of, e.g., package delivery. The residents in Dubai have to rent post office boxes and go to local post office branches to pick up their mails and packages.

The customers in places like Dubai cannot specify an actual street address when they place online orders. They have to leave a detailed description of driving direction to the delivery locations, and leave their phone numbers so that drivers of delivery companies can call the customers for direction guidance. Such a delivery process is inefficient and costly for customers, delivery companies, and sellers.

### BRIEF DESCRIPTION OF THE DRAWINGS

One or more embodiments of the present invention are illustrated by way of example and not limitation in the figures of the accompanying drawings, in which like references indicate similar elements.

FIG. 1 illustrates a home page for the social selling platform.

FIG. 2 illustrates a user dashboard for the social selling platform.

FIG. 3 illustrates a user interface for creating an online store.

FIG. 4 illustrates a user dashboard with a button for listing a product.

FIG. 5 illustrates a user interface for listing product.

FIG. 6 illustrates a webpage with a product list.

FIG. 7 illustrates a product webpage with a link for checkout.

FIG. 8 illustrates a checkout interface that requires merely a name and a phone number.

FIG. 9 illustrates an interface for orders in process.

FIG. 10 illustrates an interface for order history.

FIG. 11 illustrates a payments webpage for tracking cash on delivery.

FIG. 12 illustrates an environment in which the logistics technology integrated with the social selling platform can be implemented.

FIG. 13 illustrates an example of a process of conducting a logistics operation using mobile device location data, according to various embodiments.

FIG. 14 illustrates an example of a process of conducting a reverse logistics operation, according to various embodiments.

FIG. 15 illustrates an environment in which the logistics technology can be utilized for a delivery between two users.

FIG. 16 illustrates an example of a process of conducting a logistics operation for a delivery between two users, according to various embodiments.

FIG. 17 is a high-level block diagram showing an example of processing system in which at least some operations related to a logistics network can be implemented.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive.

Introduced here is a platform for selling products on social media (also called “social selling platform”). The platform allows anyone with a social media account to sell goods with cash on delivery to buyers. The buyers can be, e.g., fans or followers of the seller on social media, such as a professional or a personal networking service allowing for other users to “follow” the seller, and therefore, receive activity updates, contact or background information, etc. that are posted to an activity feed or associated with the seller's social media account. The seller does not need to setup any website for selling products. The seller can easily set up the webpage and link for selling the product. In some embodiments, the platform does not even charge any subscription or membership fees for selling the products. The platform is a full end-to-end solution for anyone that wants to sell products via social media channels.

In areas such as the Middle East, there are issues with payment gateway integration and ecommerce setup. To solve the problems, the platform allows seller to conveniently setup up an online store and list goods for sale. A customer can purchase the goods via a single-webpage check out interface by providing merely a name and mobile phone number. No street address is needed. The customer's delivery location is identified by using a mobile app based on Global Positioning System (GPS)/Location Based Service (LBS) technology. The platform automatically tracks the inventory and the seller's financial balance account, which includes income from collect-on-delivery.

The social selling platform is closely integrated with a logistics network for efficient delivery by using mobile device location data. The user then can use the platform as a one-stop resource for social selling, as well as product delivery. For example, the user interfaces of the social selling platform and the product delivery service can be integrated into a single mobile app. Using the mobile app, a seller can create a product webpage for selling a product and share a link to the product webpage on social media. A customer can click the shared link and make a purchase. The customer is guided through a simple and efficient checkout process that only requires a name and a phone number. Utilizing the provided phone number, the integrated delivery service can locate the customer and successfully make the delivery.

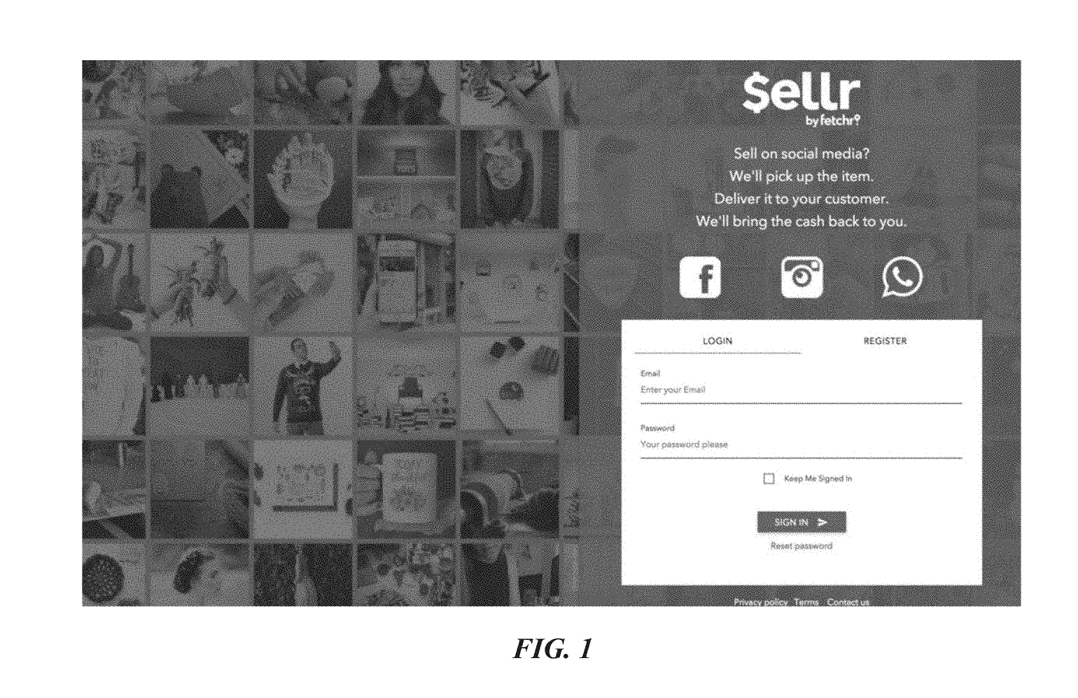

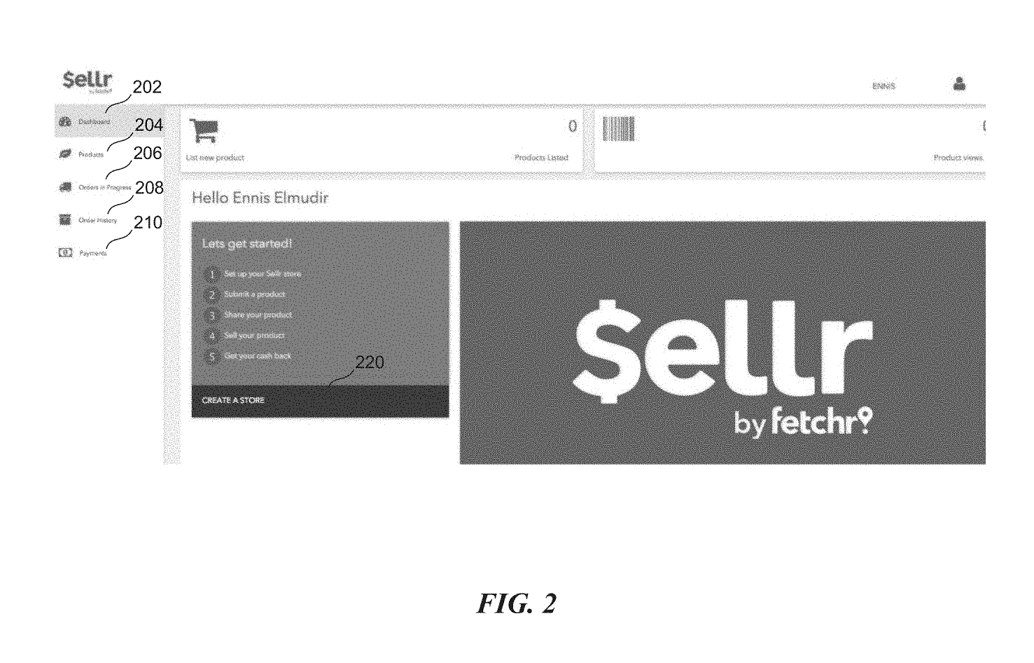

The social selling platform allows users (sellers) to create an online store with just a few clicks. FIG. 1 illustrates a home page for the social selling platform. A user can register a user account and then login using an email address and a password. Once the user is logged in, the platform shows a user dashboard. FIG. 2 shows a user dashboard for the social selling platform. The left side column of the user dashboard contains links for the user dashboard 202, the products interface 204, the orders in progress interface 206, order history interface 208 and payments interface 210. The user can click a “CREATE A STORE” button 220 to be directed to a user interface for creating a store for selling products.

In some embodiments, the dashboard can contain links to use tutorials and overviews for the virtual stores created by the user. The dashboard also can show the number of how many people are viewing or have viewed the listed products.

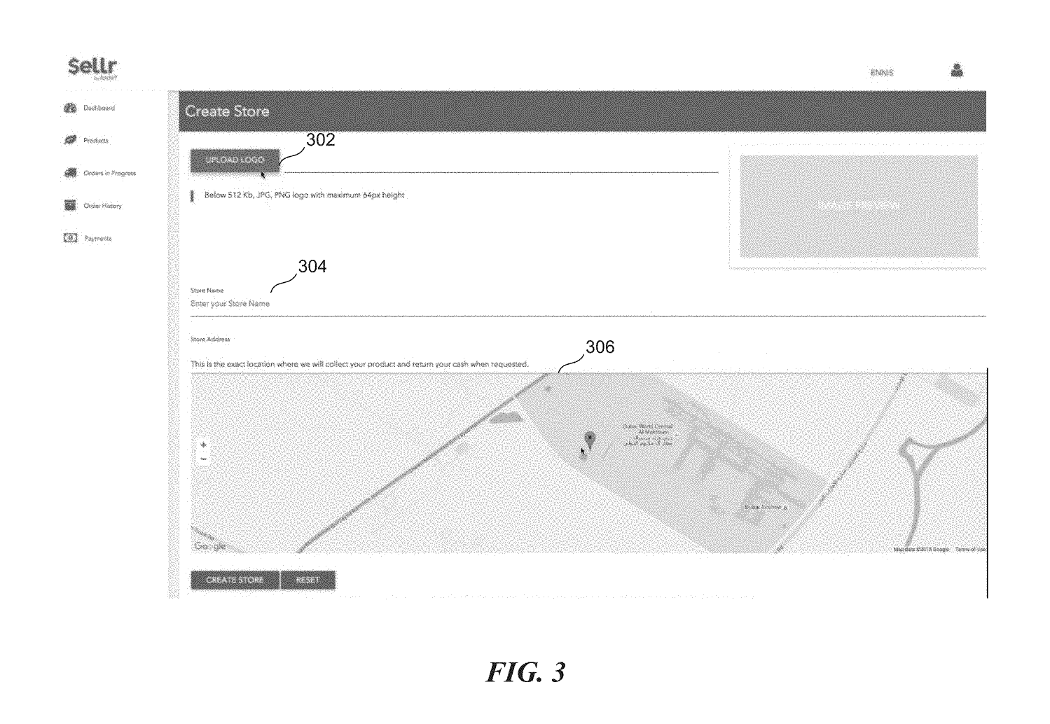

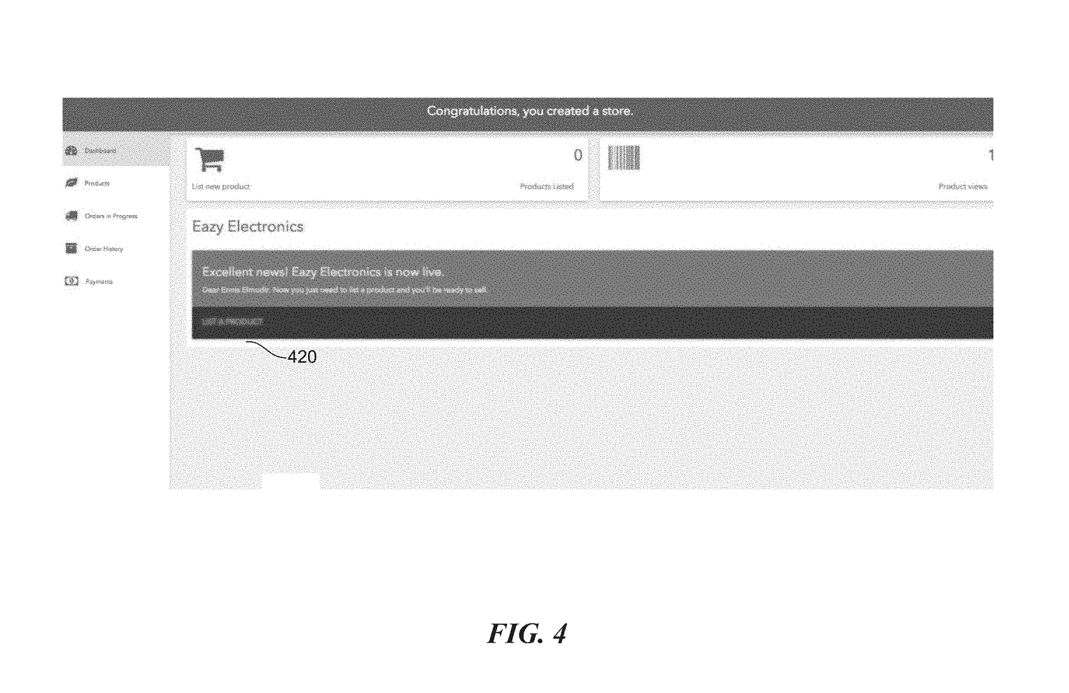

After clicking the “CREATE A STORE” button 220, the user is directed to a user interface for creating a store as illustrated in FIG. 3. The interface allows the user to upload a logo for the store (302), enter the store name (304), and choose a location for logistics service provider to pick up the goods on a map (306). Once the store is created, the user is directed back to the dashboard as shown in FIG. 4. But instead of showing the “CREATE A STORE” button, now the platform in FIG. 4 shows a “LIST A PRODUCT” button 420. The user can click the “LIST A PRODUCT” button 420 to enter an interface for listing products.

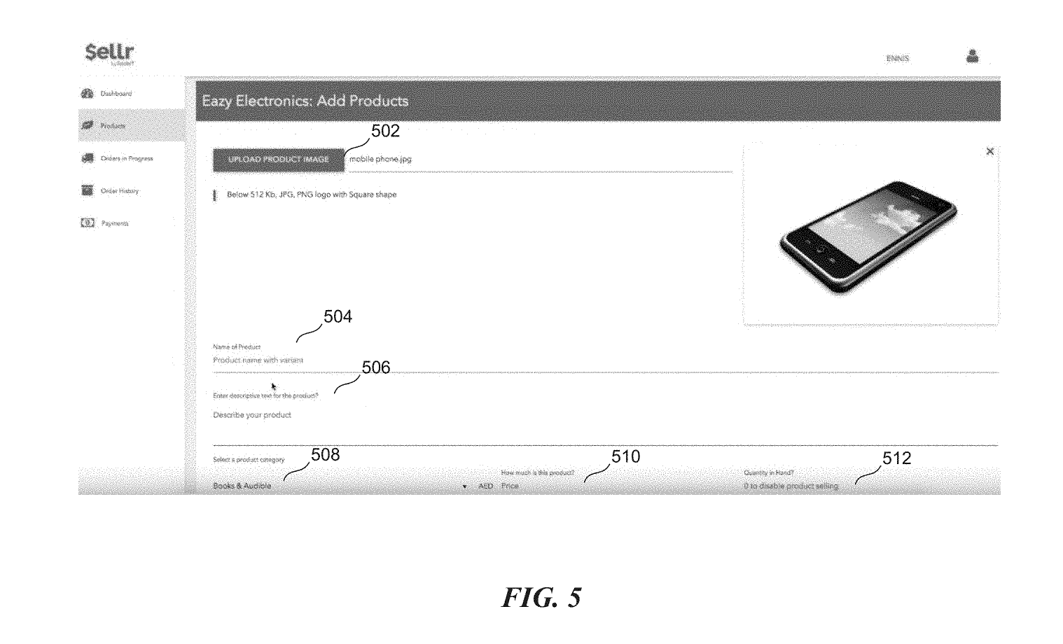

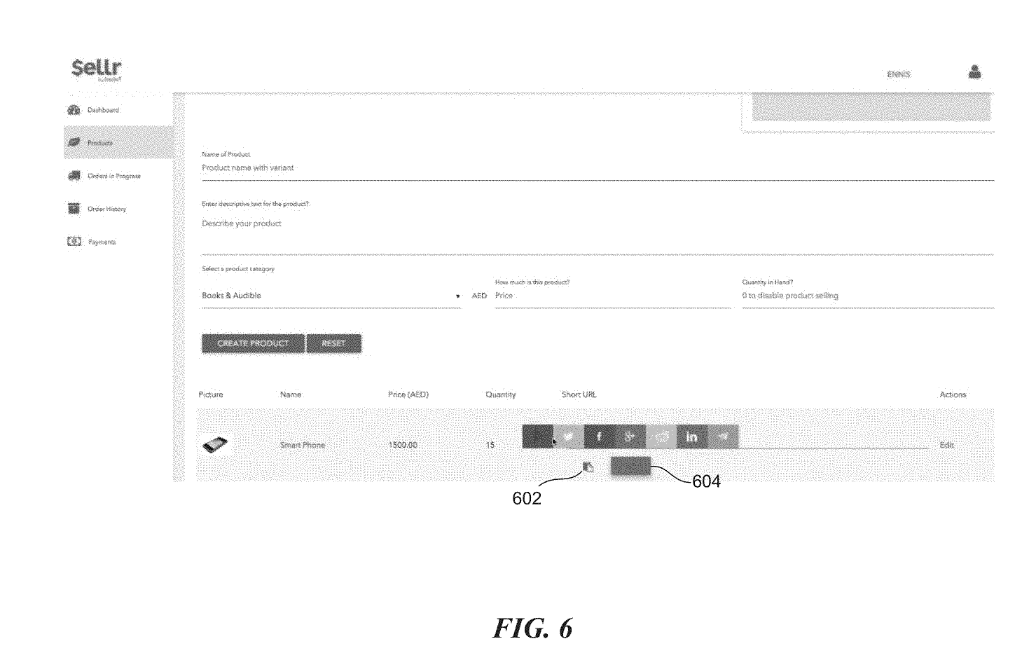

As illustrated in FIG. 5, the interface for listing products allows the user to upload a product image (502), enter a name (504) and description (506) for the product, and specify a product category (508), product price (510) and quantity in stock (512). After the user clicks the “CREATE PRODUCT” button, the entered product is listed on the bottom of the webpage. As illustrated in FIG. 6, the product list includes a short web link that links to the product webpage (“product link” 602), and a share icon for the user to share the link instantly to one of the social media platforms of the user's choice (such as Instagram®, Twitter®, Facebook®, Snapchat® or any social media medium the user uses to interact with the customers).

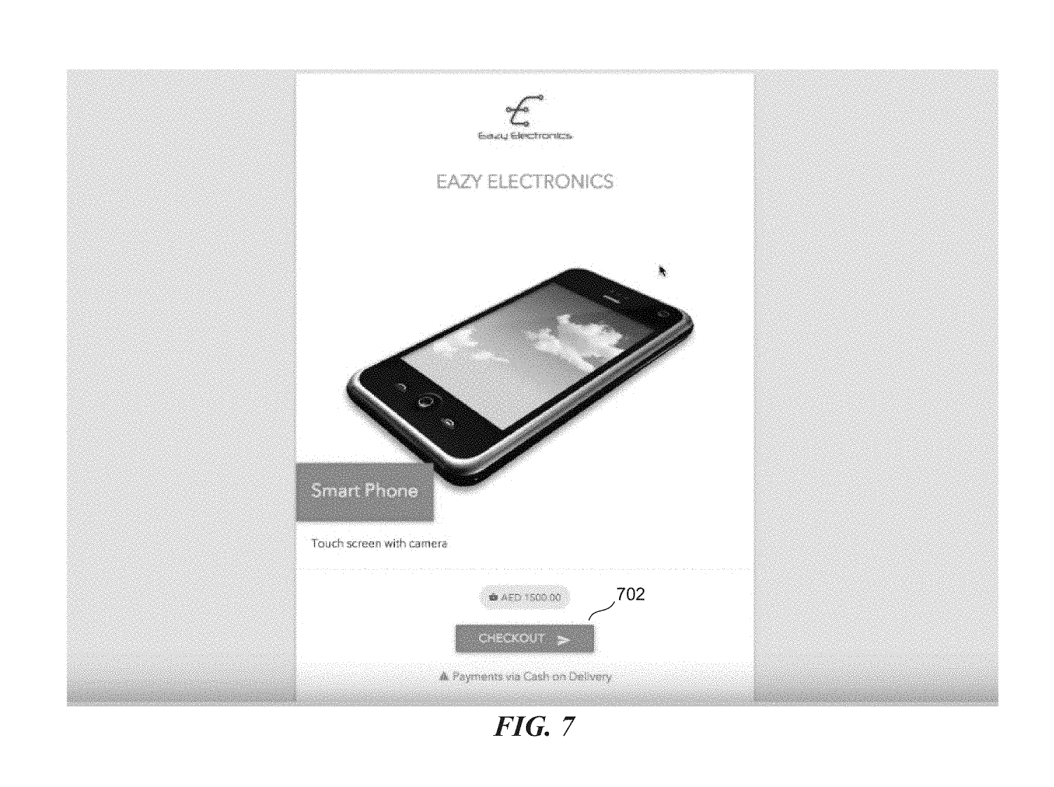

A customer can click a product link placed by the seller on social media. When a customer clicks the product link, the customer is directed to a product webpage as illustrated in FIG. 7. Through the product webpage, the customer can choose to purchase the product through the social selling platform and have it shipped to the customer via the integrated logistics delivery service. From the product webpage, the customer can check out in one easy step by clicking the “CHECKOUT” button 702.

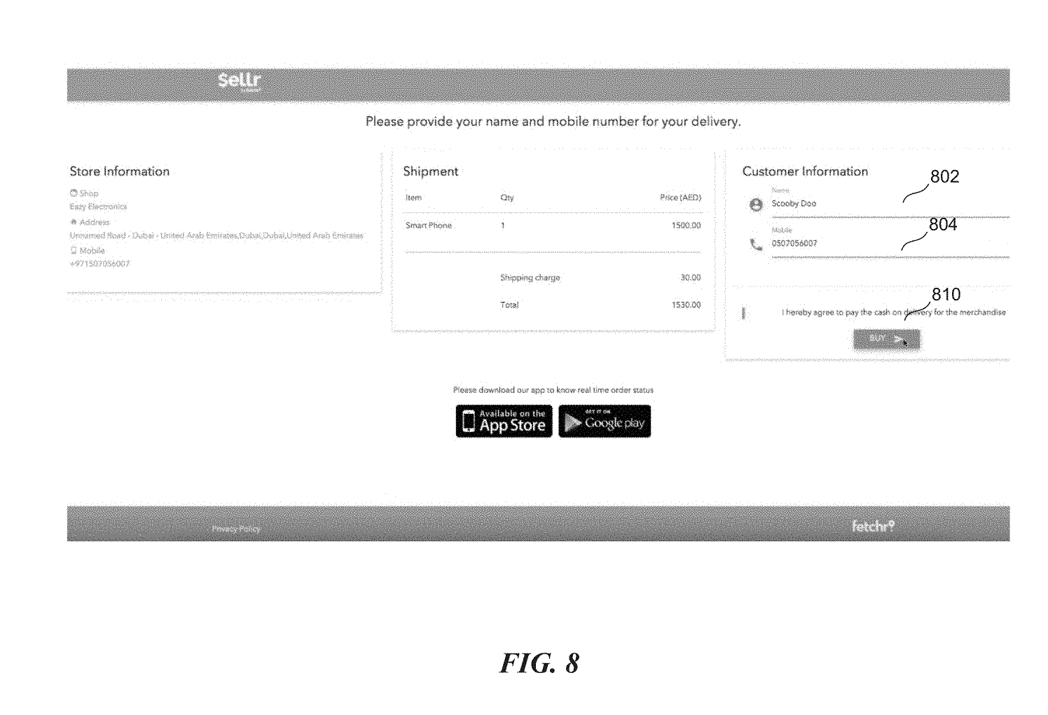

Then the customer is directed to the checkout interface as illustrated in FIG. 8. The only thing that the customer needs to do is to enter the name (802) and phone number (804) of the customer, and to click the “BUY” button 810. In some implementations, the name and phone number of the customer can be obtained from the social network that the customer used to purchase the product (i.e., the social network in which the link was posted to). For example, the customer may have an account with the social network with their personal details, such as their name, username, and phone number available. This information may be exchanged between the social network and the social selling platform, for example, via an application programming interface (API) facilitating the exchange of data. In another implementation, the data may be provided via a query string of the uniform resource locator (URL) of the product link. The customer does not even need to provide the delivery street address or delivery location information. The integrated logistics delivery service will use a location based service associated with the phone number to locate the customer for delivery purposes.

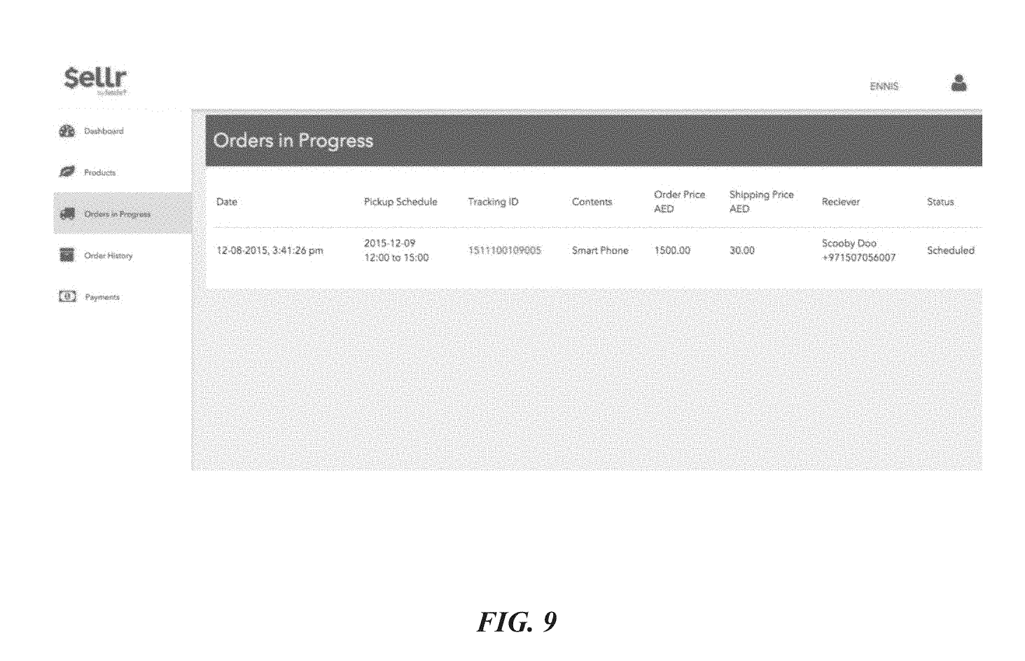

Once the platform receives the order, the order is listed in an interface for orders in process as illustrated in FIG. 9. The interface shows the order date, estimated pickup schedule, tracking ID, content description, order price, shipping price, receiver's name and phone number and the shipping status.

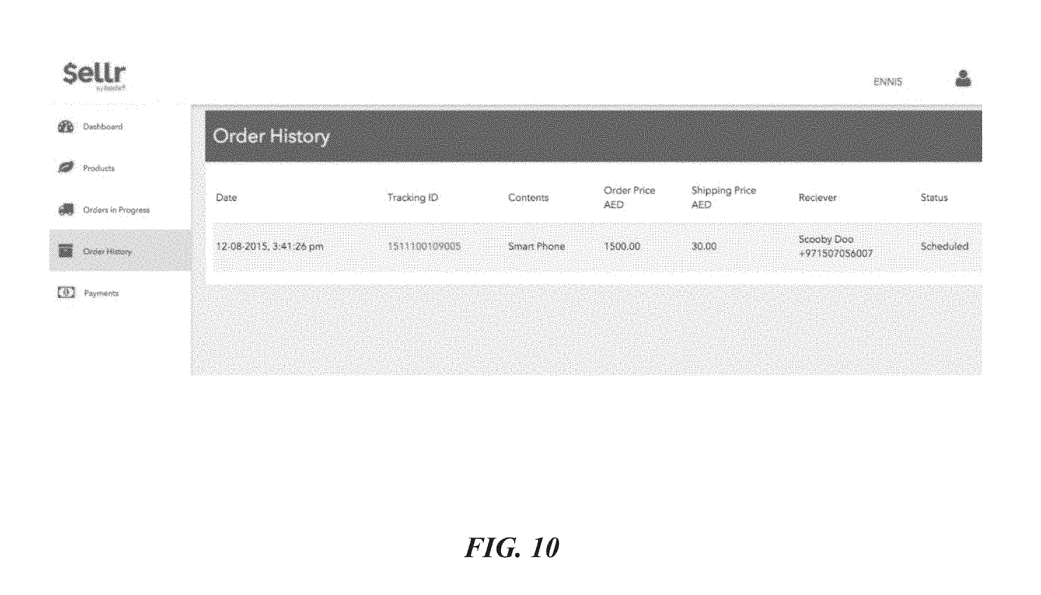

Upon delivery, the customer can pay with cash. Once the order is delivered, the order is completed. FIG. 10 shows an interface for order history. The interface lists all previous orders, including orders that are placed, scheduled for delivery, or completed.

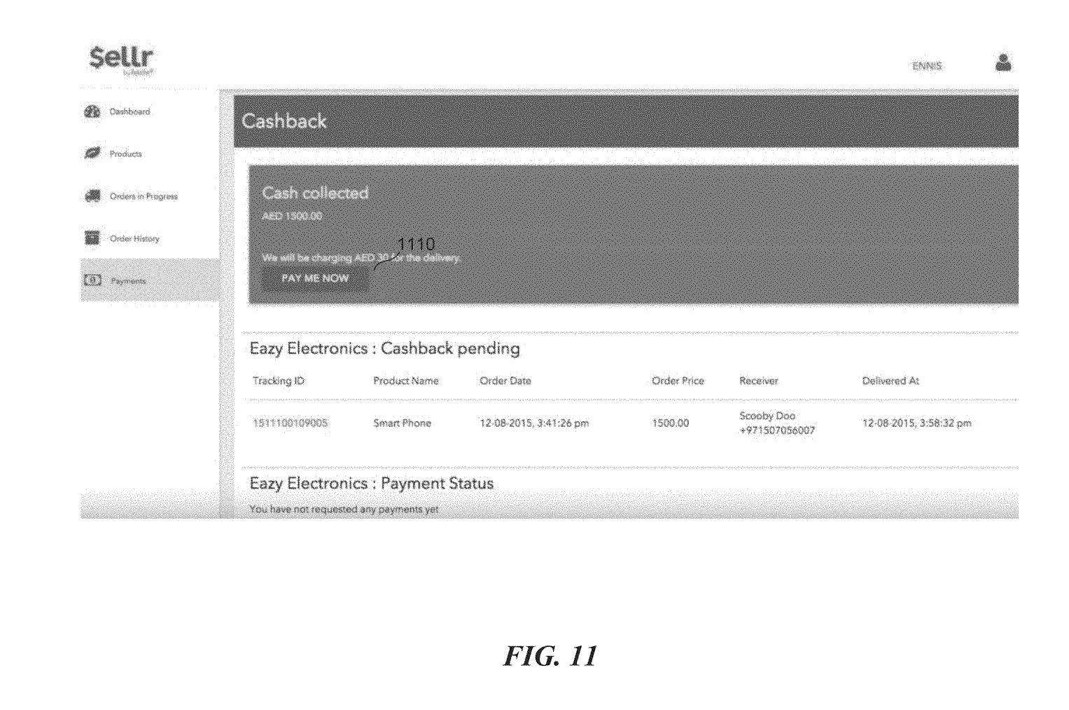

Once the customer pays the cash on delivery, the platform updates the seller's account associated with the social selling platform to reflect the transaction, for example, by adding a value corresponding to the cash collected on delivery to the seller's financial account. This results in the financial data of the seller of the social selling platform to be updated, for example, by modifying a database record associated with the seller and indicating the balance of the seller's financial account. The balance of the financial account and the COD transactions are tracked in the payments webpage as illustrated in FIG. 11. The seller can choose to receive payment from the financial account by clicking the “PAY ME NOW” button 1110. For example, the social seller can select to have the cash delivered by the integrated logistics service with a click of a button.

In some embodiments, the platform can include additional webpages (also referred to as tabs) for various functionalities. For example, the platform can include a product tab containing an overview of all available stock that the social seller have for sale. The list of available stock includes an image, a price and the location map specifying the pickup location. The platform can includes a store tab allowing the user to manage and edit existing store settings and features. The platform can further include a shipments tab allowing the user to track current existing deliveries, orders in progress and orders completed. The platform can include a cash tab allowing the user to track how much cash on delivery (COD) owned to the user and to schedule returning the COD to the user.

The social selling platform is closely integrated with location-based logistics service. The social selling platform can be implemented as, e.g., a website or part of a mobile app for the logistics service. The logistics service enables an efficient logistics network by using mobile device location data. The technology retrieves location data (e.g., GPS coordinates) of mobile devices used by the customers. The location data of the customers' mobile devices are used to suggest the logistics delivery and pickup locations. Drivers of the logistics network are equipped with logistics driver devices connected to a logistics data server for retrieving the location data and other information. Using the location data, logistics driver devices guide the drivers to reach the target locations for the delivery or pickup tasks. The technology does not necessarily need the street house numbers as delivery or pickup addresses, which are not available in some areas of the world. As a result, navigation systems and techniques for logistics drivers can be improved, for example, by increasing delivery options to locations that do not have street numbers. Moreover, the subject matter described herein also facilitates solutions to Internet and business challenges, for example, by coordinating between sellers, buyers, and logistics drivers for pickups and deliveries. Such a solution can allow for a full end-to-end solution for anyone that wants to sell or purchase products via social media channels. The location data are stored in a database for expediting future delivery or pickup requests.

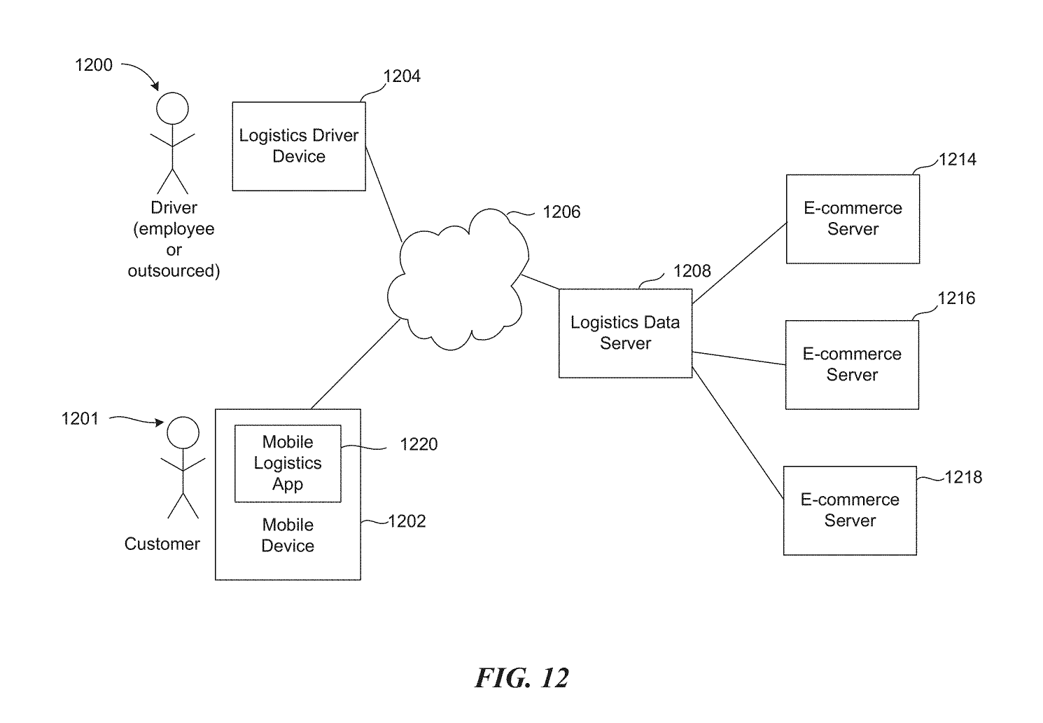

FIG. 12 illustrates an environment in which the logistics technology can be implemented. The environment includes a mobile device 1202 of a customer 1201 (also referred to as “consumer” or “user”), and a logistics driver device 1204 operated by a driver 1200. The customer 1201 can be the one who just placed the order through the checkout interface as illustrated in FIG. 8. Some or all of the drivers can be employees of the owner or operator of the logistics network. Alternatively, the owner or operator of the logistics network can outsource some or all of the drivers by contracting out of some of the driver business to another party. The mobile device 1202 can be, for example, a smart phone, tablet computer, notebook computer, or any other form of mobile or desktop processing device. A mobile logistics application 1220 runs on the consumer's mobile device 1202. The logistics driver device 1204 can be also, for example, a smart phone, tablet computer, notebook computer, or any other form of mobile processing device. Alternatively, the logistics driver device 1204 can be a computing device integrated with the vehicle of the driver 1200.

The environment also includes a server 1208 of a logistics data tracking and management system (hereinafter “logistics data server 1208”), and computer systems 1214, 1216 and 1218 of various e-commerce companies (hereinafter “e-commerce servers 1214, 1216 and 1218”). For example, one of the computer systems can be the one host the product page created at the interface illustrated in FIG. 5. Each of the aforementioned computer systems can include one or more distinct physical computers and/or other processing devices which, in the case of multiple devices, can be connected to each other through one or more wired and/or wireless networks.

The mobile device 1202 and the logistics driver device 1204 can be coupled to the logistics data server 1208 through an internetwork 1206, which can be or include the Internet and one or more wireless networks (e.g., a WiFi network and or a cellular telecommunications network). The e-commerce servers 1214, 1216 and 1218 can be coupled to the logistics data server 1208 through the internetwork 1206 as well. Alternatively, the e-commerce servers 1214, 1216 and 1218 can be coupled to the logistics data server 1208 through one or more dedicated networks, such as fiber networks.

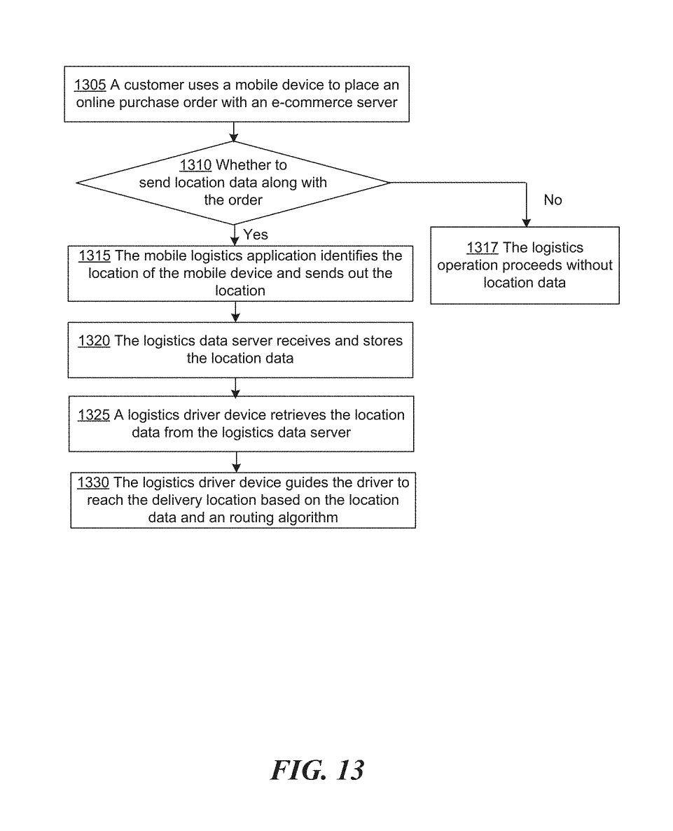

FIG. 13 illustrates an example of a process of conducting a logistics operation using mobile device location data, according to various embodiments. Initially, the customer 1201 may use the mobile device 1202 to place an online purchase order with, e.g., the e-commerce server 1214 (block 1305). The order can be placed through the mobile logistics application 1220 or another application running on the mobile device 1202, for example, the mobile app of the social selling platform as discussed above. The mobile logistics application 1220 detects the placed order and prompts the consumer 1201 via a display of the mobile device 1202 whether to send a location along with the order to the e-commerce server 1214 (block 1310). The consumer 1201 confirms sending the location by, e.g., click “yes” button on the prompt interface. In response to the consumer 1201's confirmation, the mobile logistics application identifies the location of the mobile device 1202 and sends out the location data (block 1315). The mobile logistics application 1220 may further identify a category or type of the location, such as “residence,” “work,” or “school.” The consumer 1201 may further specify the preferred delivery data and/or time based on the user inputs. The consumer 1201 can add additional specifications (e.g., “Deliver to neighbor”, “Deliver to another customer”). If the consumer chooses to not sending the location data, the logistics operation can proceed without the help of the location data (block 1317).

The location of the mobile device 1202 can be identified using various technologies of the mobile device 1202. For instance, the mobile device 1202 may determine a set of location coordinates based on a satellite navigation system (e.g., GPS, GLONASS, Beidou, or Galileo). The mobile device 1202 may further identify its accurate location within a building using positioning signals such as Assisted GPS (A-GPS). Alternatively, the mobile device 1202 may determine its location based on the cellphone network (e.g., cell identification or triangulation) or the WiFi network. The mobile device 1202 can further use a combination of the technologies to determine its location. As a result, the mobile device 1202 can determine its location using its own hardware and/or software capabilities, for example using any one or more of a satellite navigation system, positioning signals, cellphone networks, or WiFi networks. For example, mobile device 1202 may use its GPS circuitry and software to determine its location and generate GPS coordinates. These GPS coordinates are then provided as location data to logistics data server 1208. Accordingly, mobile device 1202 can determine its physical location without reference to a street and number of a building on that street (i.e., without a reference to a street address). Rather, a location generated by mobile device 1202's own location determination capabilities is used to provide the location data.

The logistics data server 1208 receives the location data from the mobile device 1202, and may further relay the location data to the e-commerce server 1214. The logistics data server 1208 stores the location data and its category (if any) in its database (block 1320). The location entry in the database may be identified by a cellphone number of the mobile device 1202, name or ID number of the consumer 1201, or other types of identification of the consumer 1201. That is, the location data generated by mobile device 1202 is associated or linked with the phone number or name (or other contact or identification information) of the customer that was previously provided during the checkout process, as discussed above. For example, a database record can be updated to have the location data related to the name and/or phone number of the customer. The database of the logistics data server 1208 may further store the information of the purchase order including, e.g., order number or preferred delivery date and time, customer name as well as any other information deemed important.

The location data of customers' mobile devices form an internal address system for the customers. Even for areas having no street house number scheme, delivery agencies can use the location data to identify and reach the delivery locations.

To fulfill the customer's purchase order, the e-commerce server 1214 determines that a package (i.e., the product that the customer ordered) has been tendered to a delivery agency. For example, logistics data server 1208 or e-commerce server 1214 can generate a delivery task for the package to be picked up and delivered to the customer to fulfill the purchase order. The delivery task may be provided to many drivers of one or more delivery agencies and one of the drivers may be selected to fulfill the purchase order. A driver 1200 of the delivery agency is responsible for delivering the package. The logistics driver device 1204 of the driver 1200 retrieves the location data (e.g., GPS coordinates) from the logistics data server 1208 (block 1325). For example, the delivery task may indicate the customer's contact information (e.g., phone number). Using that contact information, the location data of the customer can be determined by using the internal address system for the customers, as discussed above. For example, the contact information can be used to look up the customer's associated location data, which can provide the delivery location in the form of GPS coordinates since it was generated using the mobile phone's location determination capabilities. Based on the location data, the logistics driver device 1204 can use a routing algorithm to define an optimal route that guides the driver 1200 to reach the delivery location (e.g., via GPS navigation) (block 1330). The logistics driver device 1204 may send its own location and information regarding the delivery to the logistics data server 1208. In some implementations, the location data may be updated or modified from the time that the location data was first stored in the internal address system and when the driver receives the location data. For example, if the customer has changed locations (e.g., the order was first placed at the customer's workplace, but then the customer has returned to their home residence), then the location data can be updated. This can help the logistics driver delivery the package to the most up-to-date location of the customer. In some implementations, mobile device 1202 can determine that the second location is outside of a threshold distance range from the first location, and therefore, provides new location data associated to logistics data server 1208 or e-commerce server 1214. In some implementations, if the second location is of a different type or category (as previously discussed) than the first location, then new location data may be provided. If the first and second locations are the same type, then in some implementations the location data may not be updated.

The consumer 1201 can check the order status and delivery status on the mobile logistics application 1220 running on the mobile device 1202. The mobile logistics application 1220 retrieves the location information of the logistics driver device 1204 from the logistics data server 1208. Based on the information of the driver 1200, the consumer 1201 is aware of the status including, e.g., whether the package is out for delivery, or whether the driver's next stop is to deliver the package of the consumer 1201, what is the exact current location of the driver 1200, or what is the estimated time of arrival.

The process helps to predict the day and date of the delivery. The customer does not have to wait for the delivery specified by a delivery agency. Instead, based on the historical order and delivery information of consumer 1201, the logistics data server 1208 predicts the location and the time of the day that the customer is likely to receive a given delivery. Based on the prediction, the logistics driver device 1204 inserts the delivery task into its routing schedule and notifies the logistics data server 1208. The logistics data server 1208 pushes this information to the customer's mobile device 1202 to notify the customer of the expected delivery time based on consumer 1201's specified delivery location. Predicting the time of the day for the delivery and inserting the delivery task into the routing schedule to fulfill the delivery based on the predicted time can provide a more efficient schedule for deliveries. Moreover, this may ensure that the customer is available at the location to receive the delivery. Accordingly, this is one of the many techniques described herein in which navigation routing can be improved.

In some embodiments, the logistics data server 1208 can further establish a communication platform (or channel, interface, etc.) between the mobile device 1202 and the logistics driver device 1204. For instance, via the logistics data server 1208, the mobile logistics application 1220 may send a consumer's message to the logistics driver device 1204 to indicate the latest information required to perform the delivery, such as “please leave the package at the front desk,” “please come inside the building through the back door,” or “please deliver to the 37th floor.” In some implementations, logistics data server 1208 can receive the messages and update the location data for the customer. For example, if the customer provides a message stating “please leave the package next door” and the location data indicates GPS coordinates for the customer, then the GPS coordinates may be modified to reflect the adjustments to the delivery indicated in the message. In this example, the GPS coordinates can be modified to the location next door.

Similarly, the driver 1200 using the logistics driver device 1204 can send messages to the consumer 1201 using the mobile device 1202. For instance, the driver 1200 may manually send an estimated time of arrival to the consumer 1201. If the building of the location has multiple tenants or occupants, the driver 1200 may inquire the consumer 1201 to clarify the actual delivery location in the building.

The logistics data server 1208 can also send tracking information of the delivery process to the e-commerce servers 1214, 1216 and 1218. Each delivery can be identified using a unique ID number (e.g., using an order number or a logistics tracking number). Through the data pipelines between the logistics data server 1208 and the e-commerce servers, e-commerce companies can track the delivery status in real time.

In some embodiments, the logistics data server 1208 can create a marketplace where the drivers can bid for delivery and pickup jobs. The logistics data server 1208 can push the information of the jobs to the logistics driver devices 1204. For example, the logistics driver devices 1204 can display, e.g., “task x to be accomplished,” “picking up at place x at time xxx,” delivery to place with GPS coordinate xxxx at time yyyy,” etc. The drivers can bid for the jobs through the logistics driver devices 1204 or other electronic devices. The logistics data server 1208 can determine which driver wins the bidding based on multiple factors, e.g., past performance of the driver on jobs, driver' ability to complete the jobs, etc. The logistics data server 1208 can also consider the price offered by the drivers for completing the job during the determination process. The logistics data server 1208 can combine the delivery and the pickup as a single job for the bidding purpose, or treat the delivery and the pickup as separate jobs (inbound and outbound jobs).

In some embodiments, the logistics data server 1208 can handle logistics tasks associated with economic situations other than online e-commerce. For example, a government can have logistics needs for delivering official documents (e.g., government issued ID cards) to customers or citizens. The logistics data server 1208 can be used to handle the delivery of the official documents.

Furthermore, the logistics data server 1208 can be used in mature economies for customers who want to receive anything wherever they are, no matter what their official addresses are. In some of the places for pickups or deliveries, street numbers are not available, or the street numbers are not used for delivery or pickup of the order for convenience or any other reasons.

Those skilled in the art will appreciate that the logic illustrated in FIG. 2 and described above, and in each of the flow diagrams discussed below, may be altered in a variety of ways. For example, the order of the logic may be rearranged, substeps may be performed in parallel, illustrated logic may be omitted, other logic may be included, etc. The substeps of the FIG. 2 can be combined into a single process.

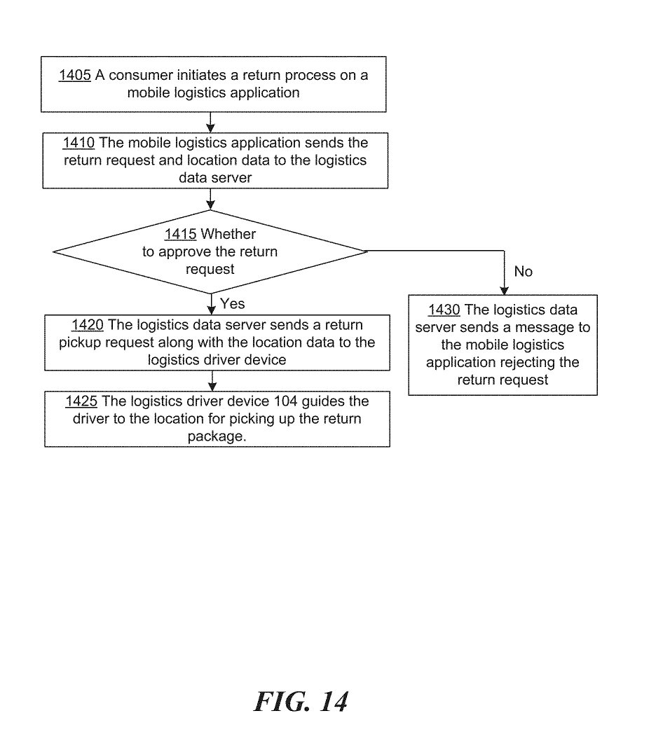

Similarly, a consumer 1201 can initiate a return process (i.e., reverse logistics). FIG. 14 illustrates an example of a process of conducting a reverse logistics operation, according to various embodiments. The consumer 1201 initiates the return process on the mobile logistics application 1220 (block 1405). The mobile logistics application 1220 may send the return request and the location data to the logistics data server 1208 (block 1410). Alternatively, the mobile logistics application 1220 may not need to send out the location data. The consumer 1201 may confirm that the return pickup location is the same as the previously sent order delivery location. The logistics data server 1208 may use the previously stored location data.

The logistics data server 1208 determines whether to approve or deny the return request (block 1415). Alternatively, the logistics data server 1208 may forward the return request to the e-commerce servers 1214, 1216 or 1218, and retrieve the approval or denial from the e-commerce servers. Once the return request is approved, the logistics data server sends a pickup request to the logistics driver device 1204, along with the location data (block 1420). The logistics driver device 1204 guides the driver 1200 to the location for picking up the return package (block 1425). If the return request is denied, the logistics data server 1208 sends a message to the mobile logistics application 1220 rejecting the pickup request (block 1430).

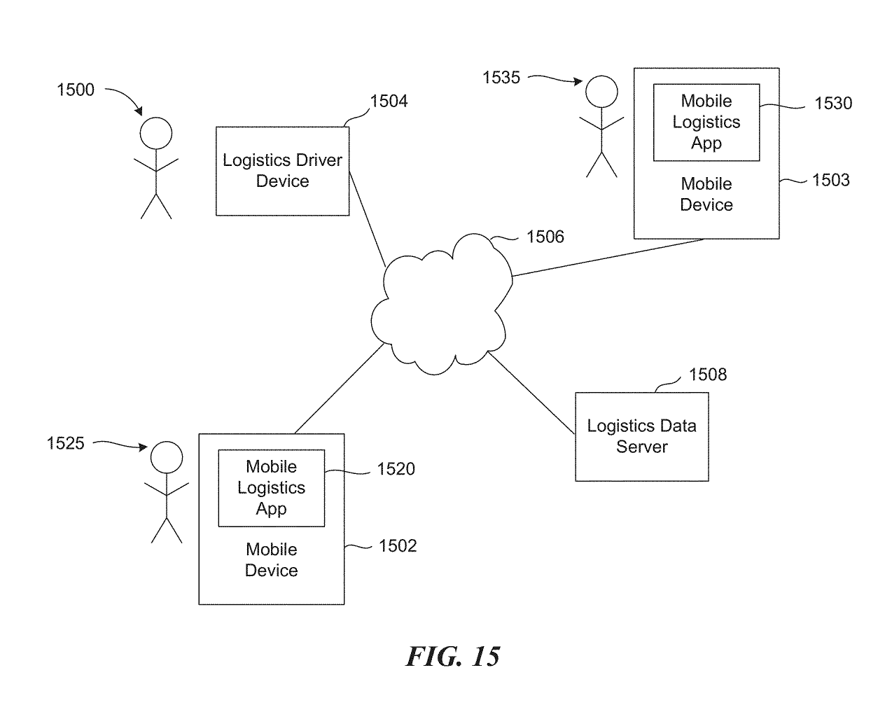

The logistics technology can be applied to a delivery between a commercial company and a customer, as well as a delivery between two customers (also referred to as “users”). FIG. 15 illustrates an environment in which the logistics technology can be utilized for a delivery between two users. The environment include a mobile device 1502 of a user 1525, a mobile device 1503 of another user 1535 and a logistics driver device 1504 operated by a driver 1500. One of the users 1525 and 1535 can be a seller who creates a product webpage and shares a link to the product webpage on social media for sales purpose. Another can be a customer who clicks the link shared on social media and enters a name and a phone number during the checkout process (e.g., via the interface illustrated in FIG. 8) for order delivery purposes.

The mobile devices 1502 and 1503 can be, for example, a smart phone, tablet computer, notebook computer, or any other form of processing device. Mobile logistics applications 1520 and 1530 run on the mobile devices 1502 and 1503 respectively. The logistics driver device 1504 can be also, for example, a smart phone, tablet computer, notebook computer, or any other form of processing device. Alternatively, the logistics driver device 1504 can be a computing device integrated with a vehicle of the driver 1200.

The environment also includes logistics data server 1508, which can include one or more distinct physical computers and/or other processing devices which, in the case of multiple devices, can be connected to each other through one or more wired and/or wireless networks. The mobile devices 1502 and 1503 and the logistics driver device 1504 can be coupled to the logistics data server 1508 through an internetwork 1206, which can be or include the Internet and one or more wireless networks (e.g., a WiFi network and or a cellular telecommunications network).

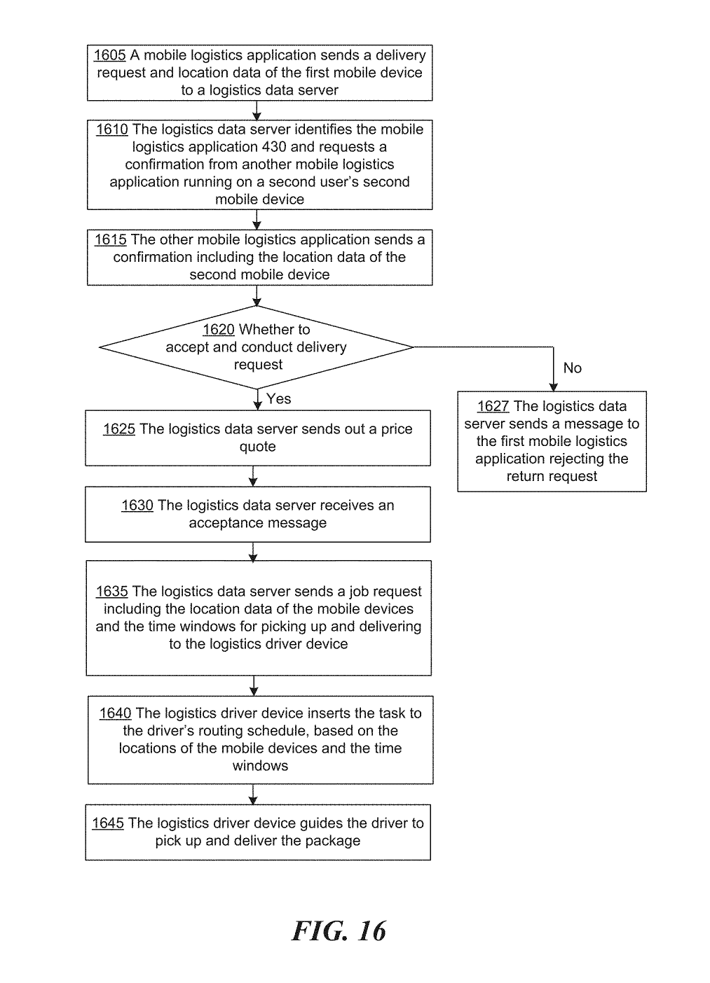

FIG. 16 illustrates an example of a process of conducting a logistics operation for a delivery between two users, according to various embodiments. The users 1525 and 1535 may be a seller and a buyer on an internet consumer-to-consumer auction website, or simply two persons who want to delivery packages or mails between each other.

The user 1525 uses the mobile logistics application 1520 running on the mobile device 1502 to initiate a request for delivery. The mobile logistics application sends the delivery request and location data of the mobile device 1502 to the logistics data server 1508 (block 1605). The delivery request can include, e.g., the identification of the user 1535, the information of the package (e.g., weight and size), time windows for picking up the package and delivering the package, and an amount to be collected if cash-on-delivery is requested, or any additional information considered essential to complete the delivery.

Based on the identification of the user 1535, the logistics data server 1508 identifies the mobile logistics application 1530 and requests a confirmation from the mobile logistics application running on user 1535's mobile device 1503 (block 1610). In response, the mobile logistics application 1530 sends a confirmation including the location data of the mobile device 1503 to the logistics data server 1508 (block 1615) In response to the confirmation, the logistics data server 1508 determines whether to accept and conduct the delivery request (block 1620). The logistics data server 1508 may make the determination based on, e.g., the location data of the mobile devices 1502 and 1503, the information of the package, etc.

In some embodiments, the logistics data server 1508 can communicate with a server of an electronic marketplace (e.g., eBay®) to receive data regarding the transaction, the buyer and the seller. Using the data, the logistics data server 1508 initiates the process of collecting the cash (if the transaction involves cash on delivery), picking up of the product from the seller and delivering the product to the buyer.

If the logistics data server 1508 determines to accept and conduct the delivery request, the logistics data server 1508 may send a price quote to the mobile logistics application 1520 or 1530, depending on whether the user 1525 or the user 1535 is to pay the logistics cost (block 1625). In response, the mobile logistics application 1520 or 1530 can send an acceptance message to confirm and accept the price quote (block 1630).

If the logistics data server 1508 determines to reject the delivery request, it sends a message to the mobile logistics application 1520 rejecting the return request.

In response to the acceptance message, the logistics data server 1508 sends a job request including the location data of the mobile devices 1502 and 1503 and the time windows for picking up and delivering to the logistics driver device 1504 (block 1635). The logistics driver device 1504 (or the logistics data server 1508 if the process is automated) inserts the delivery task to the driver's routing schedule, based on the locations of the mobile devices 1502 and 1503 and the time windows (block 1640). The logistics driver device 1504 then guides the driver 1500 to pick up the package from the user 1525 and to deliver the package to the user 1535 (block 1645). If cash-on-delivery is requested, the logistics driver device 1504 may prompt the driver 1500 to collect an indicated amount of cash from the user 1535 when the package is delivered.

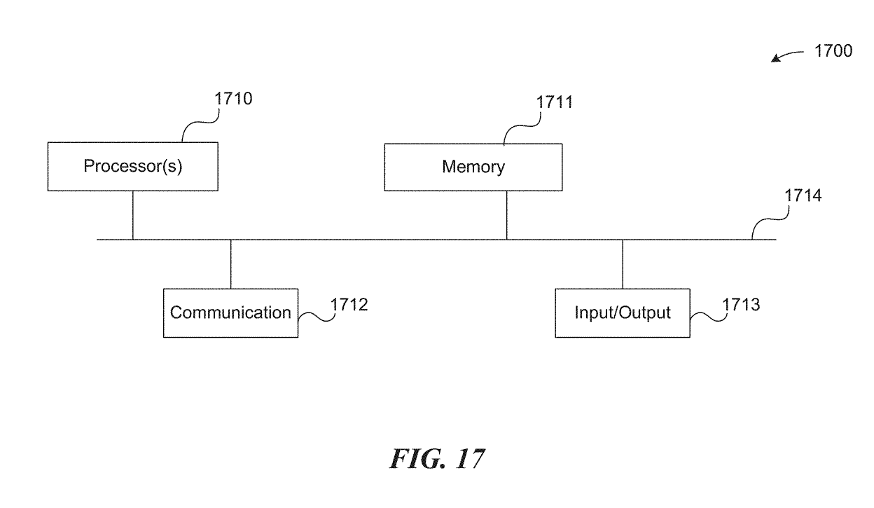

FIG. 17 is a high-level block diagram showing an example of a processing device 1700 that can represent any of the devices described above, such as the mobile devices, the logistics driver device, the logistics data server, or the e-commerce servers. As noted above, any of these systems may include two or more processing devices such as represented in FIG. 17, which may be coupled to each other via a network or multiple networks.

In the illustrated embodiment, the processing system 1700 includes one or more processors 1710, memory 1711, a communication device 1712, and one or more input/output (I/O) devices 1713, all coupled to each other through an interconnect 1714. The interconnect 1714 may be or include one or more conductive traces, buses, point-to-point connections, controllers, adapters and/or other conventional connection devices. The processor(s) 1710 may be or include, for example, one or more general-purpose programmable microprocessors, microcontrollers, application specific integrated circuits (ASICs), programmable gate arrays, or the like, or a combination of such devices. The processor(s) 1710 control the overall operation of the processing device 1700. Memory 1711 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 1711 may store data and instructions that configure the processor(s) 1710 to execute operations in accordance with the techniques described above. The communication device 1712 may be or include, for example, an Ethernet adapter, cable modem, Wi-Fi adapter, cellular transceiver, Bluetooth transceiver, or the like, or a combination thereof. Depending on the specific nature and purpose of the processing device 1700, the I/O devices 1713 can include devices such as a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a non-transitory machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A computer-implemented method for facilitating logistics navigation of commercial goods without a physical address, the method comprising:
receiving, by a logistics data server, a request from a customer to have a product delivered to the customer, the request indicating contact information of the customer and location data representing a geographic location without the physical address of a mobile device of the customer, the geographic location determined by the mobile device using its location determination capabilities;
storing, in a user location database of the logistics data server, the location data of the mobile device as being associated with the contact information of the customer;
generating, by the logistics data server, a delivery task for delivering the product to the customer and indicating the contact information of the customer;
broadcasting, by the logistics data server, the delivery task to one or more logistics driver devices;
receiving, by the logistics data server, a confirmation from one of the logistics driver devices confirming that a logistics driver associated with the logistics driver device will fulfill the delivery task;
receiving, by the logistics data server, from the logistics driver device, a request for the location data associated with the customer information of the customer indicated by the delivery task; and
sending, by the logistics data server, to the logistics driver device, the location data of the mobile device associated with the contact information of the customer to fulfill the delivery task.

2. The method of claim 1, further comprising:
determining, by the logistics data server, a target time window for the delivery task based on historical order information of the customer, and wherein broadcasting the delivery task is based on fulfilling the delivery task within the target time window.

3. The method of claim 2, wherein the target time window for the delivery task is further based on historical delivery information of the customer.

4. The method of claim 2, further comprising:
causing, by the logistics data server, the logistics driver device to update a routing schedule of the logistics driver device to include a navigation route from a location at which the product is tendered to the logistics driver to the geographic location of the mobile device.

5. The method of claim 1, wherein the geographic location represented by the location data is based on one or more of a location corresponding to a satellite navigation system, a location corresponding to a cellphone network, or a location corresponding to a wireless network.

6. The method of claim 1, wherein broadcasting the delivery task includes a request for bids to fulfill the delivery task, and the confirming that the logistics driver associated with the logistics driver device will fulfill the delivery task corresponds to the logistics driver providing a winning bid to fulfill the delivery task.

7. The method of claim 6, wherein the winning bid is based on one or more of past performance of the logistics driver, ability of the logistics driver to fulfill the delivery task, or a price offered by the logistics driver for fulfilling the delivery task.

8. The method of claim 1, further comprising:
receiving, by the logistics data server, from the logistics driver device, a confirmation that the delivery task has been completed; and
updating, by the logistics server, a seller account associated with the product to reflect completion of the delivery task.

9. A system comprising:
a processor; and
memory including instructions that, when executed by the processor, cause the system to:
receive a request from a customer to have a product delivered to the customer, the request including contact information of the customer and location data representing a geographic location without the physical address of a mobile device of the customer, the geographic location determined by the mobile device using its location determination capabilities;
store, in a user location database, the location data of the mobile device as being associated with the contact information of the customer;
generate a logistical delivery task for delivering the product to the customer and indicating the contact information of the customer;
broadcast the delivery task to one or more logistics driver devices;
receive a confirmation from one of the logistics driver devices confirming that a logistics driver associated with the logistics driver device will fulfill the delivery task;
receive from the logistics driver device, a request for the location data associated with the customer information of the customer indicated by the delivery task; and
send to the logistics driver device, the location data of the mobile device associated with the contact information of the customer to fulfill the delivery task.

10. The system of claim 9, further caused to:
determine a target time window for the delivery task based on historical order information of the customer, and wherein broadcasting the delivery task is based on fulfilling the delivery task within the target time window.

11. The system of claim 10, wherein the target time window for the delivery task is further based on historical delivery information of the customer.

12. The system of claim 10, further caused to:
cause the logistics driver device to update a routing schedule of the logistics driver device to include a navigation route from a location at which the product is tendered to the logistics driver to the geographic location represented by the location data.

13. The system of claim 9, wherein the geographic location represented by the location data of the customer is based on one or more of a location corresponding to a satellite navigation system, a location corresponding to a cellphone network, or a location corresponding to a wireless network.

14. The system of claim 9, wherein broadcasting the delivery task includes a request for bids to fulfill the delivery task, and the confirming that the logistics driver associated with the logistics driver device will fulfill the delivery task corresponds to the logistics driver providing a winning bid to fulfill the delivery task.

15. The system of claim 14, wherein the winning bid is based on one or more of past performance of the logistics driver, ability of the logistics driver to fulfill the delivery task, or a price offered by the logistics driver for fulfilling the delivery task.

16. The method of claim 9, further caused to:
receive, from the logistics driver device, a confirmation that the delivery task has been completed; and
update a seller account associated with the product to reflect completion of the delivery task.

17. A non-transitory computer-readable storage medium including instructions which, when executed by a processor of a computing system, cause the computing system to:
receive a request from a customer to have a product delivered to the customer, the request including contact information of the customer and location data representing a geographic location without the physical address of a mobile device of the customer, the geographic location determined by the mobile device using its location determination capabilities;
store, in a user location database, the location data of the mobile device as being associated with the contact information of the customer;
generate a logistical delivery task for delivering the product to the customer and indicating the contact information of the customer;
broadcast the delivery task to one or more logistics driver devices;
receive a confirmation from one of the logistics driver devices confirming that a logistics driver associated with the logistics driver device will fulfill the delivery task;
receive from the logistics driver device, a request for the location data associated with the customer information of the customer indicated by the delivery task; and
send to the logistics driver device, the location data of the mobile device associated with the contact information of the customer to fulfill the delivery task.

18. The non-transitory computer-readable storage medium of claim 17, further caused to:
determine a target time window for the delivery task based on historical order information of the customer, and wherein broadcasting the delivery task is based on fulfilling the delivery task within the target time window.

19. The non-transitory computer-readable storage medium of claim 18, wherein the target time window for the delivery task is further based on historical delivery information of the customer.

20. The non-transitory computer-readable storage medium of claim 18, further caused to:
cause the logistics driver device to update a routing schedule of the logistics driver device to include a navigation route from a location at which the product is tendered to the logistics driver to the geographic location represented by the location data.

21. The non-transitory computer-readable storage medium of claim 17, wherein the geographic location represented by the location data of the customer is based on one or more of a location corresponding to a satellite navigation system, a location corresponding to a cellphone network, or a location corresponding to a wireless network.

22. The non-transitory computer-readable storage medium of claim 17, wherein broadcasting the delivery task includes a request for bids to fulfill the delivery task, and the confirming that the logistics driver associated with the logistics driver device will fulfill the delivery task corresponds to the logistics driver providing a winning bid to fulfill the delivery task.
